(19) United States
(12) Patent Application Publication
(10) Pub. No.: US 2010/0054555 A1
(43) Pub. Date: Mar. 4, 2010

(54) SYSTEMS AND METHODS FOR USE OF IMAGE RECOGNITION FOR HANGING PROTOCOL DETERMINATION

(75) Inventor: Frank J. Owen, Elmhurst, IL (US)

Correspondence Address: HANLEY, FLIGHT & ZIMMERMAN, LLC, 150 S. WACKER DRIVE, SUITE 2100, CHICAGO, IL, 60606, US

(73) Assignee: GENERAL ELECTRIC COMPANY, Schenectady, NY (US)

(21) Appl. No.: 12/201,652

(22) Filed: Aug. 29, 2008

(51) Int. Cl. G06K 9/00

(52) U.S. Cl. 382/128

(57) ABSTRACT

Certain embodiments of the present invention provide methods and systems for determining a hanging or display protocol to display an image study. Certain embodiments provide a method for determining a protocol for display of an image study. The method includes comparing at least one query image from an image study to a database of reference images to identify at least one resultant image. The method additionally includes extracting one or more characteristics from the at least one resultant image. The method also includes applying a series of filters to a set of display protocols based on the one or more characteristics to determine a subset of the set of display protocols, at least one of the series of filters including an image recognition filter. The method further includes providing a display protocol from the subset of the set of display protocols for display of the image study.

### BACKGROUND OF THE INVENTION

The present invention generally relates to hanging protocol configuration in a picture archiving and communication system. In particular, certain embodiments of the present invention relate to use of image recognition for hanging protocol determination in a picture archiving and communication system.

Healthcare environments, such as hospitals or clinics, include clinical information systems, such as hospital information systems (“HIS”) and radiology information systems (“RIS”), and storage systems, such as picture archiving and communication systems (“PACS”). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools.

PACS connect to medical diagnostic imaging devices and employ an acquisition gateway (between the acquisition device and the PACS), storage and archiving units, display workstations, databases, and sophisticated data processors. These components are integrated together by a communication network and data management system. A PACS has, in general, the overall goals of streamlining health-care operations, facilitating distributed remote examination and diagnosis, and improving patient care.

A typical application of a PACS system is to provide one or more medical images for examination by a medical professional. For example, a PACS system can provide a series of x-ray images to a display workstation where the images are displayed for a radiologist to perform a diagnostic examination. Based on the presentation of these images, the radiologist can provide a diagnosis. For example, the radiologist can diagnose a tumor or lesion in x-ray images of a patient's lungs.

Current PACS systems use general techniques known as “hanging protocols” to format display or layout of images. Hanging protocols allow a user to display images based on modality, anatomy, and procedure. Hanging protocols present a perspective or view to a user, such as a radiologist. Images may be grouped according to characteristics such as a Digital Imaging and Communications in Medicine (“DICOM”) series or series number.

Additionally, PACS systems attempt to prepare images for viewing by users by applying a series of processing steps or functions included in a Default Display Protocol (“DDP”). A DDP is a default workflow that applies a series of image processing functions to image data to prepare the image data for presentation to a user on a particular monitor configuration. DDPs typically include processing steps or functions that are applied before any diagnostic examination of the images. A DDP may be based on a type of imaging modality used to obtain the image data, for example. In general, a DDP attempts to present image data in a manner most useful to many users.

Often, images are poorly characterized due to inadequate or missing metadata stored with the images. This leads to inappropriate identification of the study and/or images, and ultimately leads to the wrong banging protocol being applied to the case, since traditionally, banging protocol selection is based on metadata contained in the images and/or exam database (for example, Modality, Procedure Codes, Body Part, Series Descriptions, etc.).

### BRIEF SUMMARY OF THE INVENTION

Certain embodiments of the present invention provide methods and systems for determining a hanging or display protocol to display an image study.

Certain embodiments provide a method for determining a protocol for display of an image study. The method includes comparing at least one query image from an image study to a database of reference images to identify at least one resultant image. The method additionally includes extracting one or more characteristics from the at least one resultant image. The method also includes applying a series of filters to a set of display protocols based on the one or more characteristics to determine a subset of the set of display protocols, at least one of the series of filters including an image recognition filter. The method further includes providing a display protocol from the subset of the set of display protocols for display of the image study.

Certain embodiments provide a system for determining a protocol for display of an image study. The system includes an input receiving a query image for display protocol selection. The system also includes an image engine receiving the query image and selecting a display protocol based on the image. The image engine compares the query image to a database of reference images to identify a resultant image, extracts one or more characteristics from the resultant image, and applies a series of filters including an image recognition filter to a set of display protocols based on the one or more characteristics to determine a subset of the set of display protocols. The system further includes an output providing a display protocol from the subset of the set of display protocols for display of the image study.

Certain embodiments provide a machine-readable storage medium including a set of instructions for execution on a processor. The set of instructions includes an input routine receiving a query image for display protocol selection. The set of instructions also includes an image retrieval routine receiving the query image and selecting a display protocol based on the image. The image retrieval routine compares the query image to a database of reference images to identify a resultant image, extracts one or more characteristics from the resultant image, and applies a series of filters including an image recognition filter to a set of display protocols based on the one or more characteristics to determine a subset of the set of display protocols. The set of instructions further includes an output routine providing a display protocol from the subset of the set of display protocols for display of the image study.

### BRIEF DESCRIPTION OF SEVERAL VIEWS OF THE DRAWINGS

FIG. 1 illustrates an exemplary picture archiving and communication system.

FIG. 2 illustrates an exemplary sequence of events for protocol selection.

FIG. 3 illustrates an exemplary use of selection factors to determine an appropriate DDP for a given exam.

FIG. 4 illustrates an exemplary use of selection filters to determine an appropriate DDP for a given exam according to certain embodiments.

FIG. 5 illustrates an exemplary DDP filter interface according to certain embodiments.

FIG. 6 illustrates an exemplary Fire DDP filter in accordance with certain embodiments.

FIG. 7 illustrates an exemplary Fire DDP filter in accordance with certain embodiments.

FIG. 8 illustrates a flow diagram for a method for determining an appropriate hanging protocol for display in accordance with certain embodiments.

FIG. 9 illustrates a flow diagram for a method for applying a hanging protocol to a workstation display in accordance with certain embodiments.

FIG. 10 illustrates an exemplary clinical information system that can be used in accordance with certain embodiments of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide systems and methods for determination of hanging protocols using image recognition. Certain embodiments provide an enhancement to hanging protocol methods used on radiology diagnostic review workstations. Certain embodiments apply image recognition technology to characterize medical images. Recognition-based characterization supplements explicit characterization when explicit characterization is missing or incomplete.

Certain embodiments use a database of images that have already been characterized. For example, hanging protocol selection criterion, such as modality, procedure code, body part, etc., have been accurately associated with the images in a preselected prototype image database. An unknown or poorly characterized image is then used as a query image on this database to find close-match cases (e.g., images that “look like” the query image). When a query of the database results in a set of images, the characterizations of the matching images can be used instead of the query image to characterize the image. The unknown or poorly-characterized image is thus better defined because it “looks like” some other well-known, well-characterized image. If the image “looks like” an axial computed tomography (“CT”) image of the head, for example, then the image can be treated as such for the purposes of determining and applying a hanging protocol.

In certain embodiments, once a type of images is determined, hanging protocol-matching techniques can be applied. Using image recognition, display workstation software can “look at” the images in situations where other metadata are missing in order to determine that the “CT-head with contrast” protocol should be used to display the exam.

Thus, rather than relying on metadata that is stored with an image, which can often be inadequate or missing, certain embodiments attempt to determine a type of image and/or exam by “looking at” the image(s) and by comparing the image(s) with other images in a prototype database. The image itself is used to make a characterization.

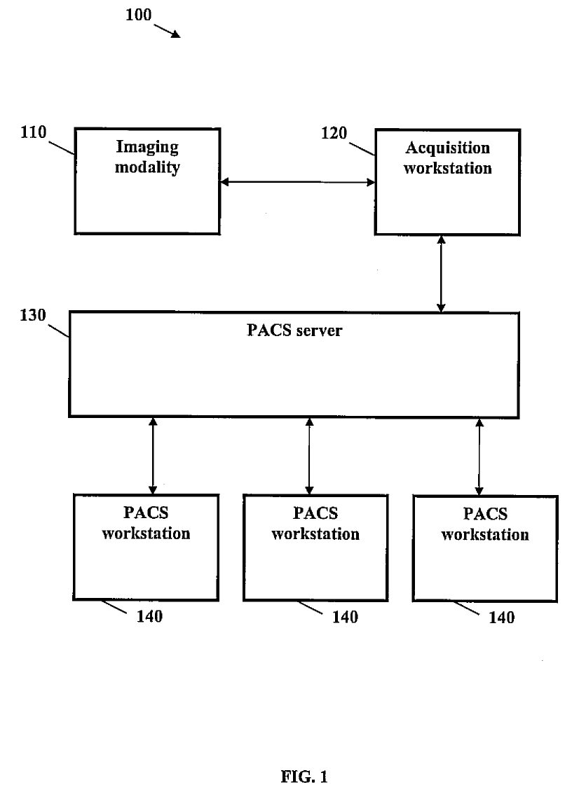

FIG. 1 illustrates an exemplary Picture Archiving and Communication System (“PACS”) 100 used in accordance with an embodiment of the present invention. The PACS system 100 includes an imaging modality 110, an acquisition workstation 120, a PACS server 130, and one or more PACS workstations 140. The system 100 may include any number of imaging modalities 110, acquisition workstations 120, PACS server 130 and PACS workstations 140 and is not in any way limited to the embodiment of system 100 illustrated in FIG. 1. The components of the system 100 may communicate via wired and/or wireless communication, for example, and may be separate systems and/or integrated to varying degrees, for example.

In operation, the imaging modality 110 obtains one or more images of a patient anatomy. The imaging modality 110 may include any device capable of capturing an image of a patient anatomy such as a medical diagnostic imaging device. For example, the imaging modality 110 may include an X-ray imager, ultrasound scanner, magnetic resonance imager, or the like. Image data representative of the image(s) is communicated between the imaging modality 110 and the acquisition workstation 120. The image data may be communicated electronically over a wired or wireless connection, for example.

In an embodiment, the acquisition workstation 120 may apply one or more preprocessing functions, for example, to the image data in order to prepare the image for viewing on a PACS workstation 140. For example, the acquisition workstation 120 may convert raw image data into a DICOM standard format or attach a DICOM header. Preprocessing functions may be characterized as modality-specific enhancements, for example (e.g., contrast or frequency compensation functions specific to a particular X-ray imaging device), applied at the beginning of an imaging and display workflow. The preprocessing functions differ from processing functions applied to image data in that the processing functions are not modality specific and are instead applied at the end of the imaging and display workflow (for example, at a display workstation 140).

The image data may then be communicated between the acquisition workstation 120 and the PACS server 130. The image data may be communicated electronically over a wired or wireless connection, for example.

The PACS server 130 may include computer-readable storage media suitable for storing the image data for later retrieval and viewing at a PACS workstation 140. The PACS server 130 may also include one or more software applications for additional processing and/or preprocessing of the image data by one or more PACS workstations 140.

One or more PACS workstations 140 are capable of or configured to communicate with the server 130. The PACS workstations 140 may include a general purpose processing circuit, a PACS server 130 interface, a software memory, and/or an image display monitor, for example. The PACS server 130 interface may be implemented as a network card connecting to a TCP/IP based network, but may also be implemented as a parallel port interface, for example.

The PACS workstations 140 may retrieve or receive image data from the server 130 for display to one or more users. For example, a PACS workstation 140 may retrieve or receive image data representative of a computed radiography (“CR”) image of a patient's chest. A radiologist or user may then examine the image for any objects of interest, such as tumors, lesions, etc., for example.

The PACS workstations 140 may also be capable of or configured to apply processing functions to image data. For example, a user may desire to apply processing functions to enhance features within an image representative of the image data. Processing functions may therefore adjust an image of a patient anatomy in order to ease a user's diagnosis of the image. Such processing functions may include any software-based application that may alter a visual appearance or representation of image data. For example, a processing function can include any one or more of flipping an image, zooming in an image, panning across an image, altering a window and/or level in a grayscale representation of the image data, and altering a contrast and/or brightness an image.

In an embodiment, the PACS system 100 may provide one or more perspectives for viewing images and/or accessing applications at a PACS workstation 140. Perspectives may be provided locally at the PACS workstation 140 and/or remotely from the PACS server 130. In an embodiment, the PACS system 100 includes a perspectives manager capable of being used for reviewing images via a plurality of perspectives. The PACS server 130 and/or a PACS workstation 140 may include the perspectives manager, or the perspectives manager may be implemented in a separate system. In an embodiment, each PACS workstation 140 may include a perspectives manager.

In operation, for example, a user, such as a radiologist, selects a set of images, such as screening mammogram images, chest screening images and/or other computed radiography (“CR”), digital radiography (“DR”), and/or digital x-ray (“DX”) screening images, to review at a PACS workstation 140. The images may be displayed in a default perspective and/or a customized perspective, for example.

As described above, a user may wish to apply additional processing steps to one or more images to further enhance features in the image. For example, a user may desire to apply additional processing functions or steps to an image in order to alter the presentation of an image in conformance with the user's confidence level for making an accurate diagnosis. In other words, different users may desire to apply different or additional processing steps than are included in a default image processing workflow.

The additional image processing step(s) may include any image processing step useful to prepare an image for a diagnostic examination. For example, as described above, an image processing step (as a default image processing step or an additional image processing step) can include flipping an image, zooming in an image, panning across an image, and altering one or more of a window, a level, a brightness and a contrast setting of an image. Image data may be displayed on a PACS workstation 140 using the same and/or different processing, display protocol, and/or perspective as other image(s), for example.

PACS workstations 140 may retrieve or receive image data from server 130 for display to one or more users. For example, a PACS workstation 140 may retrieve or receive image data representative of a computed radiography image of a patient's chest. A radiologist may then examine the image as displayed on a display device for any objects of interest such as, for example, tumors, lesions, etc.

PACS workstations 140 are also capable of or configured to retrieve and/or receive one or more hanging protocols from server 130. For example, a default hanging protocol may be communicated to PACS workstation 140 from server 130. A hanging protocol may be communicated between server 130 and a PACS workstation 140 over a wired or wireless connection, for example.

In general, PACS workstations 140 may present images representative of image data retrieved and/or received from server 130. PACS workstations 140 may present the images according to a hanging protocol. As described above, a hanging protocol is a set of display rules for presenting, formatting and otherwise organizing images on a display device of a PACS workstation 140. A display rule is a convention for presenting one or more images in a particular temporal and/or spatial layout or sequence. For example, a hanging protocol may include a set of computer-readable instructions (or display rules, for example) that direct a computer to display a plurality of images in certain locations on a display device and/or display the plurality of images in a certain sequence or order. In another example, a hanging protocol may include a set of computer-readable instructions that direct a computer to place a plurality of images in multiple screens and/or viewports on a display device. In general, a hanging protocol may be employed to present a plurality of images for a diagnostic examination of a patient anatomy featured in the images.

A hanging protocol may direct for example, a PACS workstation 140 to display an anterior-posterior (“AP”) image adjacent to a lateral image of the same anatomy. In another example, a hanging protocol may direct PACS workstation 140 to display the AP image before displaying the lateral image. In general, a hanging protocol dictates the spatial and/or temporal presentation of a plurality of images at PACS workstation 140.

A hanging protocol may differ from a default display protocol (“DDP”). In general, a DDP is a default workflow that applies a series of image processing functions to image data. The image processing functions are applied to the image data in order to present an image (based on the image data) to a user. The image processing functions alter the appearance of image data. For example, an image processing function may alter the contrast level of an image.

DDPs typically include processing steps or functions that are applied before any diagnostic examination of the images. For example, processing functions may be applied to image data in order to enhance features within an image (based on the image data). Such processing functions can include any software-based application that may alter a visual appearance or representation of image data. For example, a processing function can include any one or more of flipping an image, zooming in an image, panning across an image, altering a window and/or level setting in a representation of the image data, and altering a contrast and/or brightness setting in a representation of the image data.

DDPs are usually based on a type of imaging modality used to obtain the image data. For example, image data obtained with a C-arm imaging device in general or a particular C-arm imaging device may have a same or similar DDP applied to the image data. In general, a DDP attempts to present image data in a manner most useful to many users.

Conversely, applying a hanging protocol to image data may not alter the appearance of an image (based on the image data), but instead may dictate how the image(s) is (are) presented, as described above.

Server 130 may store a plurality of hanging protocols and/or DDPs. The hanging protocols and/or DDPs that are stored at server 130 and have not yet been modified or customized are default hanging protocols/DDPs. A default hanging protocol and/or DDP may be selected from a plurality of default hanging protocols and/or DDPs based on any number of relevant factors such as, for example, a manual selection, a user identity, and/or pre-processing of the image data.

Specifically, a default hanging protocol and/or DDP may be selected based on a manual selection simply by communicating the default protocol once a user has selected that particular protocol. The user may make the selection, for example, at a PACS workstation 140.

In another example, a default protocol may be selected based on a user identity. For example, a user may have a preferred DDP. The DDP may have been customized to meet the user's preferences for a particular temporal and/or spatial layout of images. Once a user gains access to a PACS workstation 140 (for example, by entering a correct login and password combination or some other type of user identification procedure), the preferred DDP may be communicated to the PACS workstation 140, for example.

In another example, a default protocol may be selected based on pre-processing of image data. Pre-processing of image data may include any image processing known to those of ordinary skill in the art that prepares an image for review by a user. Pre-processing may also include, for example, a computer-aided diagnosis (“CAD”) of image data. CAD of image data may include a computer (or similar operating unit) automatically analyzing image data for objects of interest. For example, a CAD may include a software application that analyzes image data for nodules in images of lungs, lesions, tumors, etc. However, a CAD application can include any automatic analysis of image data known to those of ordinary skill in the art.

For example, a default banging protocol that corresponds to CAD findings of lung tumors may provide for the presentation of the posterior-anterior (“PA”) and lateral lung images adjacent to each other followed by the presentation of the computed tomography (“CT”) lung images, followed by the magnetic resonance (“MR”) lung images, for example. In general, a default banging protocol that corresponds to CAD findings is designed to present images in a spatial and/or temporal layout that is useful to a radiologist. For example, a radiologist may be greatly assisted in his or her review of the CAD findings by viewing the PA and lateral lung images adjacent to each other, followed by previously acquired multi-slice CT and MR images of the lungs.

Therefore, based on CAD findings, a default protocol may be selected from a plurality of default protocols and applied at a workstation 140 in order to present images to a user.

PACS users often wish to run multiple applications on a PACS workstation 140. In addition to a primary PACS workflow or interface application, a user may wish to access other applications such as surgical planning tools, scheduling tools, electronic mail viewers, image processing tools, and/or other tools. For example, PACS users often like to use a PACS workflow engine while viewing electronic mail and accessing information on the Internet. Users of an integrated RIS/PACS system may wish to access both RIS and PACS applications simultaneously. Typically, however, the PACS application occupies all active display area and hides other applications running on the workstation 140. For example, in a PACS workstation 140 having three monitors, the PACS workflow application occupies all three monitors. When an application is initiated, another application may be displaced, or the application may be launched in a sub-optimal display area. For example, a user may launch a data management or diagnostic processing software at a three-monitor PACS workstation 140, and the application may launch on a color monitor, displacing images displayed on the color monitor. Typically, a user would have to manually reorganize applications to display the management application on a grayscale monitor and the images on the higher resolution color monitor.

Certain embodiments provide an adaptable PACS system 100 accommodating a plurality of displays such that each display operates with a separate display window. All display windows are controlled internally by a primary window that is transparent to users. The primary, transparent window tracks which window or windows have the PACS application and which window(s) have other applications and/or data. Thus, the PACS application and other applications may be simultaneously displayed on a plurality of displays.

Certain embodiments provide dynamic configuration of displays associated with PACS workstation 140. The primary window allows interaction or application(s) and data across multiple windows. The PACS workstation 140 operates a transparent, primary window including a plurality of windows across a plurality of displays.

Selection of a hanging protocol on a PACS workstation may be based on a plurality of criteria, such as a number of connected displays, a modality, an anatomy, and a procedure, for example. Based on these criteria, a user may create multiple protocols with one default protocol used to display an image study. For example, a hanging protocol may be created for a particular display configuration. A user creates different hanging protocols to properly display a study on different display configurations.

However, certain embodiments allow creation of a protocol including a plurality of perspectives or views, for example. Using one protocol with multiple perspectives/views, a user may associate different perspectives/views for different display configurations with the protocol. For example, a hanging protocol may include multiple perspectives with one default perspective. The default perspective may be used to display a study unless otherwise specified and/or determined manually or automatically, for example.

In certain embodiments, hanging protocols with perspectives/views may use one or more criteria to select a protocol for display. For example, a modality, an anatomy or body part, a procedure, and/or a default view for a display configuration, may be used to select an appropriate display protocol. For example, a display protocol includes a perspective/view with multiple options depending upon monitor configuration. A user may create a hanging protocol with different view for different display configurations, for example. A user does not have to create different hanging protocols for different monitor configurations but may instead create additional views with the existing banging protocol. In certain embodiments, a user may switch between different perspectives/views after opening a study.

In certain embodiments, perspectives are views or layouts indicating visual component positioning and interactions between images and/or applications based on workflow, for example. Medical perspectives may be used to create a plurality of benefits for. For example, perspectives may provide patient context sharing between different image(s) and/or application(s) that a user views. Additionally, for example, perspectives provide an ability to easily switch between different configurations or perspectives based on which images and/or applications a user wishes to view at any given point. Furthermore, for example, perspectives provide an ability to store or “remember” specific workflow steps. Perspectives provide a mechanism to save and display information relevant to a particular user, group, and/or function, for example. Perspectives may be used to display images and other data for a particular resolution, display type, and/or other configuration, for example.

Perspectives may be used to logically group different images and/or other data or applications. For example, perspectives may be defined for images, examination results, laboratory data, patient history data, structured report data, DICOM data, and/or other data or applications, for example. Rules, configuration options, and/or other criteria may be defined in order to define perspectives. In certain embodiments, perspectives do not eliminate or change information but rather order information in a certain way. For example, information important to a user may be displayed first, with additional information available via different perspectives. In certain embodiments, perspectives may be created automatically based on user selection or other configuration information, for example. In certain embodiments, a perspective may work together with a rules-based context manager to filter and display information.

In certain embodiments, medical application perspectives are software components that save visual component positioning and interactions between medical applications and data based on workflow. Medical application perspectives are a mechanism used to create a plurality of benefits for users. For example, perspectives may provide patient context sharing between different applications, data and/or other components that a user views. Additionally, for example, perspectives provide an ability to switch between different configurations or perspectives based on which applications, data and/or other components a user wishes to view at any given point. Furthermore, for example, perspectives provide an ability to store or “remember” specific workflow steps. Perspectives provide a mechanism to save and display information relevant to a particular user, group, and/or function, for example.

Perspectives that may be saved by and/or for one or more users. For example, a perspective may include viewing an exam worklist on a color monitor, one or more images displayed on one or more diagnostic monitors, and a report editor on the bottom of the color monitor. For example, another perspective may include viewing related prior report(s) on the color monitor, related prior image(s) on one diagnostic monitor, and current image(s) on another diagnostic monitor. For example, a perspective may show viewing all labs and allergies for a period of time (e.g., two months) for a patient on the color monitor and viewing current image(s) on the diagnostic monitor(s). As another example, a perspective may include viewing any maximum intensity projection/multiplanar reconstruction (“MIP/MPR”) image set for a current exam on a diagnostic monitor.

In certain embodiments, users may “switch to” or “be assigned” a medical perspective on the fly. Based on available perspectives, a user may toggle between perspectives to read an exam or other data. A user may toggle between available perspectives using a mousing device, keyboard shortcuts, gaze tracking, and/or voice command, for example. In certain embodiments, specific workflows of individual radiologists and/or cardiologists may be stored so that each radiologists/cardiologists uses the same workflow through the same sequence of perspectives wherever the user logs in. Thus, a user has the advantage of reading exams and other data quickly and efficiently on any diagnostic workstation, for example.

In certain embodiments, software, firmware and/or hardware may verify a user's right to access one or more of the applications and/or perspectives. For example, if a user logs on to a system with perspectives, based on previous saving of a default perspective, the user is logged on automatically into RIS, PACS, and EMR systems.

Thus, a user may access relevant prior history for a patient (e.g., images and reports). Using different perspectives the user has already created, the user may switch between perspectives to view desired information. The medical application perspectives may be delivered to the user in a variety of ways. For example, perspectives may be delivered via a preselected set of components and/or workflows from a medical software and/or hardware provider. Perspectives may also be delivered via perspectives created by a system administrator. Additionally, a user may dynamically create perspectives during operation of the system 100 (i.e., “on the fly”). Thus, the user may select components and/or applications for display in viewable areas of one or more monitors based on workflow. The information/configuration may then be saved in one or more perspectives. The user may toggle between perspectives to read an exam or other data on a variety of devices such as displays and/or printers. The user may save perspectives, exams, reports, and/or other data, for example.

In an embodiment, a plurality of applications may be providing information to a radiologist, cardiologist and/or other user for diagnosis of a patient. One or more displays available to the user may not have enough screen space to display all of the information. Additionally, displaying all of the available information would be too crowded to be useful. Even if information is filtered with rules, too much information may still remain. Thus, a user may apply medical perspectives on a workstation to view information from a plurality of applications and systems. One perspective may be set up to show images and/or examination results from radiology, for example. Another perspective may be set up to show images and/or examination results from cardiology, for example. Another perspective may be set up to show images and/or examination results from imaging, for example.

Perspectives may be used to logically group different applications, for example. Rules, configuration options, and/or other criteria may be defined in order to define perspectives. Perspectives may be defined for images, examination results, laboratory data, patient history data, structured report data, DICOM data, and/or other data, for example. In certain embodiments, perspectives do not eliminate or change information but rather order information in a certain way. For example, information important to a user may be displayed first, with additional information available via different perspectives. In certain embodiments, a system may “learn” through user selection or other configuration information, for example, to create perspectives automatically without manual intervention by the user.

In certain embodiments, images in perspectives may be organized according to one or more criterion. For example, the default perspective includes a first set of images organized according to a default criterion, while the second perspective includes a second set of images organized according to a second criterion. The second criterion may be different from the default criterion, for example. Additionally, the second set of images may be a subset of the first or default set of images, which may include all available images for a subject, procedure, modality, and/or user, for example.

In certain embodiments, the criterion includes image attributes, such as procedure-specific image attributes. For example, the second perspective may be organized or laid out based on mammogram-specific image attributes found in image DICOM headers. Use of image attributes in determining a perspective layout allows precision in reproducing a perspective for each instance of a procedure, for example.

Additionally, a display protocol, such as a Default Display Protocol (“DDP”), may be adjusted for one or more displays based on content and/or a number of connected display(s). For example, if the PACS workstation 140 is reconfigured from a three monitor configuration to a one monitor configuration, the DDP may be modified accordingly. Certain embodiments adapt a DDP based on application(s) closed and/or opened as well as window(s) activated and/or deactivated. For example, a DDP may determine what information is displayed to a user. A DDP may adapt based on a number of available monitors and a number of images to be displayed, for example (e.g., four images are shown on one available display; eight images are shown on two available displays, etc). PACS workstation 140 may configure a DDP for any multi-monitor full screen and/or partial screen applications. Additionally, one or more applications may be resized on a single screen (e.g., minimize, maximize, and/or resize).

In certain embodiments, image recognition technology attempts to identify specific objects or features within an image or produce a general characterization of an image based upon examination and analysis of the image pixels themselves. Within a PACS, image recognition can be useful in a number of situations. On a PACS server, image recognition can be used in characterization of images upon acquisition into the PACS, for example. On a client workstation, image recognition can be used in characterization of images on-the-fly within the client display workstation, for example. Image recognition can also be used to assist in diagnosis by identifying pertinent regions of interest, structures, anomalies, etc.

One feature of a PACS client workstation includes automatic selection of a proper DDP and/or hanging protocol to be used when displaying a selected exam. While a DDP and a hanging protocol may differ, they may also be similar, so the terms hanging protocol and DDP will be used interchangeably for the purposes of the discussion below.

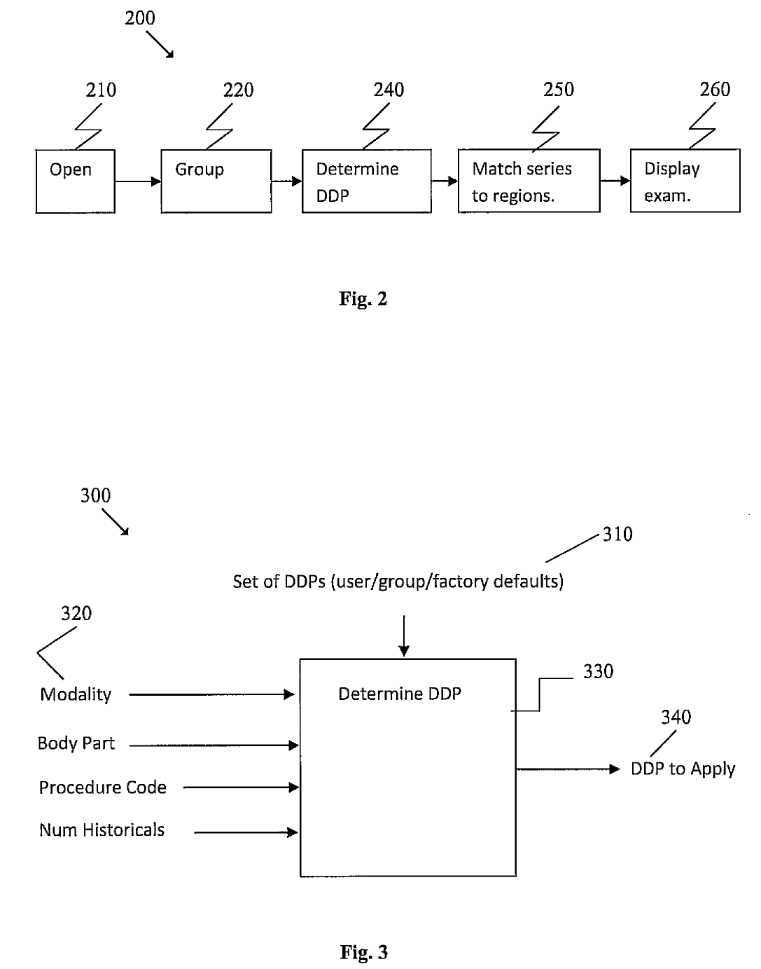

As illustrated in FIG. 2, a sequence of events 200 in protocol selection includes the following. At 210, an exam is opened. At 220, one or more exams are grouped. At 230, a DDP is determined. At 240, a series is matched to a region. At 250, the exam(s) are displayed according to the DDP. Characterization of images and/or exam types can be used in determination of a DDP, for example.

For example, an examination for a patient may be opened on a radiology review workstation. A current exam may be matched and grouped with a prior exam for that patient. A DDP is determined for the exam data. Then an image series in one or more of the exams is matched to a region on the display. The exam(s) and their component image and/or other data are displayed on the display according to the layout and other parameters provided by the DDP.

A number of factors are used to determine an appropriate DDP for a given exam. As shown in FIG. 3, an available set of DDPS 310 and one or more selection factors 320 are provided to a DDP determination engine 330 to select a DDP 340 to apply for display Selection factors 320 can include modality, body part, procedure code, numeric historical, etc. For example, a DDP can be selected based on image information indicating that the image(s) are CT images of a chest cavity using a certain procedure.

Missing or inaccurate selection factors, however, can result in determination of an improper DDP for a given exam. For example, the Procedure Code is very often not defined correctly due to manual input errors, an error-prone workflow, or inability/inconsistency of a modality to apply correct values. Additionally, a single DDP may be identified in cases where there may be ambiguity due to missing or non-specific selection factors.

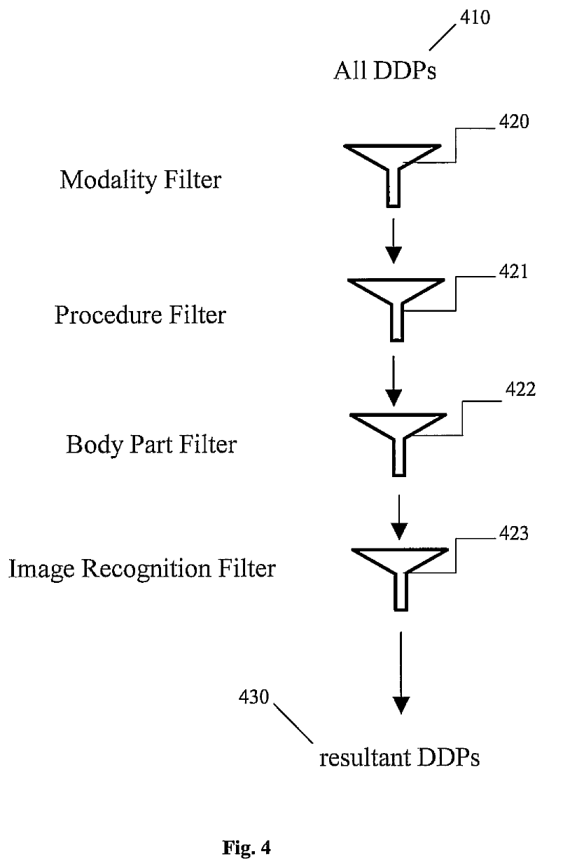

FIG. 4 illustrates a modification to the above approach. In this approach, selection factors are replaced with selection filters 420-423. Filters may include a modality filter 420, a procedure filter 421, a body part filter 422, an image recognition filter 423, and/or other applicable filter, for example. The filters 420-423 select or reduce a set of DDPs 410 to identify resultant subset of relevant DDP(s) 430 based on filter criterion. The selection filters 420-423 are designed such that their filter criterion can be dynamically adjusted in order to allow more or less items to pass through the filter. For example, the modality filter 420 can be set to only allow CT DDPs to pass through. If this strict filter setting yields no DDPs, the filter setting can be relaxed to include related modalities such as positron emission tomography (“PT”), magnetic resonance (“MR”) imaging, etc. Thus, the filter selection criterion can be continually tightened, relaxed, and/or removed in order to allow at least some DDPs to pass through. The filters 420-423 can be used in sequence so that the results of one filter propagate to the next stage, for example. The initial “strict” filter criterion can be set according to the characteristics of the exam being opened, for example. As an example, in the case of a modality filter 420, the filter criterion can be set to match the modality type of the exam. If no DDPs result using the “strict” filter setting, the filter can adjust its criterion until some DDPs are passed to the next stage.

As can be seen in FIG. 4, image recognition can impact DDP determination if the previous filter stages do not adequately filter a small enough set of DDPs for selection. For example, cases of improper/inadequate/missing attributes in the exam metadata may involve image recognition to more accurately determine DDP selection. The image recognition filter attempts to “look at” the images to identify what type of exam it is, and thereby select an appropriate DDP.

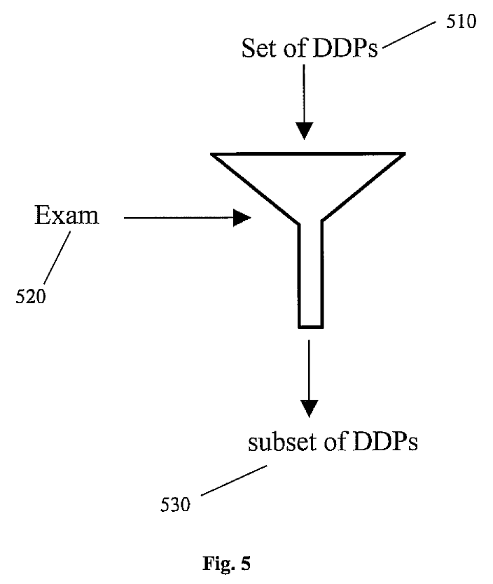

In certain embodiments, the image recognition filter discussed above is designed according to a DDP filter interface as shown in FIG. 5. As shown in FIG. 5, a set of DDPs 510 is provided and compared against an input exam 520 to produce a subset of DDPs 530 for selection for display.

The design of FIG. 5 allows for use of different image recognition techniques. The following example describes the use of the Flexible Image Retrieval Engine (“Fire”) for purposes of illustration only. The Fire can be used to select images from a user-provided database of images which are visually similar to a submitted “query” image. For the purposes of image characterization, a candidate image is first used as the “query” image for a Fire engine query. The candidate is then presumed to share known characterization(s) of matching image(s) found in the database. For example, if the Fire database is queried and results only in a Head CT image, then it can be safe to assume that the image in question is also a Head CT image.

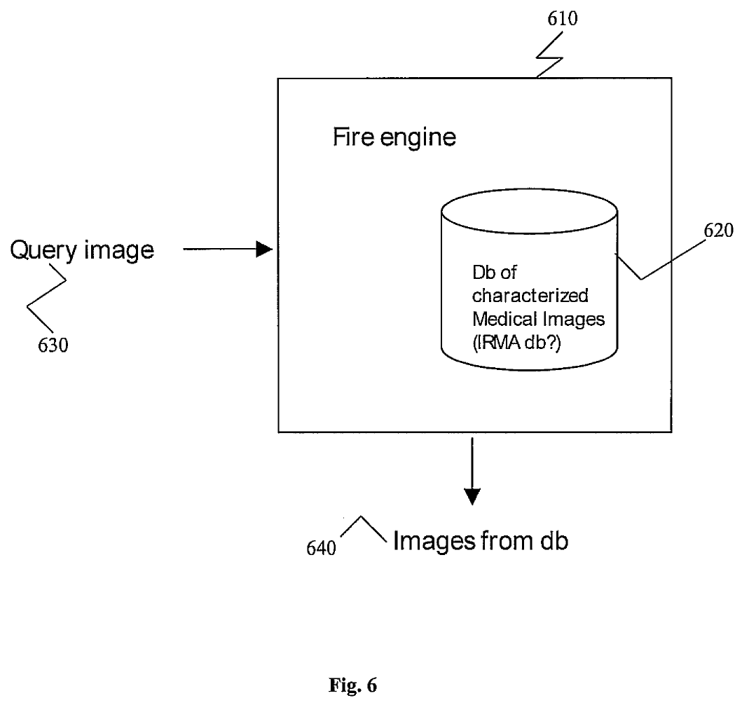

FIG. 6 illustrates an example Fire engine 610 operation. The Fire engine 610 can be deployed locally, or on a server machine accessible on the network, for example. The Fire engine 610 is initialized with a database collection of images 620. A client application submits a query image 630 (e.g., in jpeg or other standard image format) to the engine 610, and Fire 610 returns a set of “similar” images from the database 620, in order of decreasing similarity. The engine 610 can be configured to return a specific number of “best match” images, for example.

In certain embodiments, a database of images that has already been properly characterized can be used. For example, “normal” selection criterion, such as modality, procedure code, body part, etc., have been accurately associated with the images in the Fire database 620. An example of such a database or data store may include a database of reference diagnostic images including reference codes compiled by the Image Retrieval in Medical Applications (“IRMA”) project. Thus, when a query of the database 620 results in a set of images, the characterizations of the matching images can be used instead of the query image 630 in order to select DDPs.

For example, a head CT image may be identified using a database of images including head CT images that have previously been classified and verified based on modality, body part, procedure code, etc. Using image recognition techniques to identify similarities between the database/library and new image, the new or query image can be classified as a head CT image for purposes of DDP determination, for example.

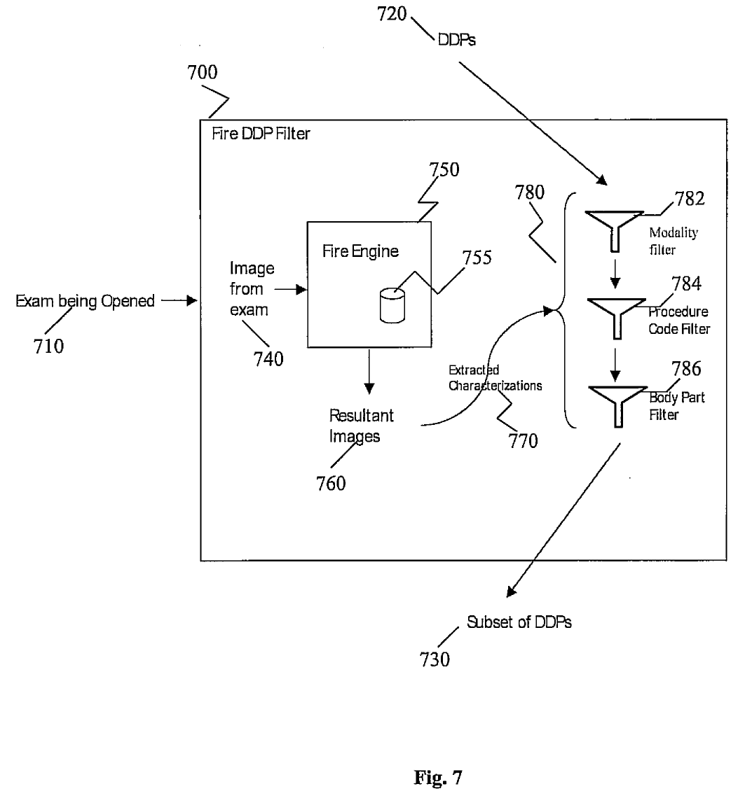

FIG. 7 illustrates operation of a Fire DDP filter 700 in accordance with certain embodiments of the present invention. The filter 700 receives as input an exam 710 being opened and a set of available DDPS 720. The filter 700 products a subset of DDPs 730 as output. An image 740 from the exam 710 is input to the Fire engine 750. The engine 750 uses an image database 755 to identify resulting relevant image(s) 760 for DDP determination based on the input image 740. Characterization(s) 770 are extracted from the resultant image(s) 760. The characterization(s) 770 are used as inputs or selectors for a plurality of filters 780 applied to the DDPs 720. Filters 780 can include a modality filter 782, a procedure code filter 784, a body part filter 786, an image recognition filter, etc. After filtering the available DDPs, a relevant subset of DDPs 730 can be provided for use in displaying images and other information.

Thus, in certain embodiments, an image recognition filter is added to the DDP determination process to help ensure an appropriate DDP is selected for an image display.

Traditionally, DDP determination is based on characterizations of an exam using data that should be entered at the time of acquisition. However, that information is often missing or incorrect and does not provide a correct match with an appropriate DDP. Misspellings in procedure code, etc., can cause errors in DDP selection and, as a result, image display. Then, a user must manually look at the exam to correct the DDP selection.

Certain embodiments provide systems and methods that automate review of an exam and determination of the content of images in the exam (e.g., head study, abdomen, etc.). Certain embodiments help to improve accuracy in selecting an appropriate DDP.

In certain embodiments, a database or library used for image recognition (e.g., a database used by a FIRE) can be constructed from typical exams for different procedures. Alternatively and/or in addition, a library or database can be populated and updated dynamically. For example, certain embodiments recognize that a DDP has been used for other types of exams and can then start populating the database with images that are known successful hits for that DDP and look for other similar exams. In certain embodiments, analysis can begin with a default set of DDPs, and the library is populated and/or modified dynamically.

In certain embodiments, banging protocol determination can be transparent to users. In certain embodiments, an indication of banging protocol determination can be provided to allow a user to agree or disagree with the determination. In certain embodiments, user input can provide feedback to build up additional knowledge and improve accuracy in the future.

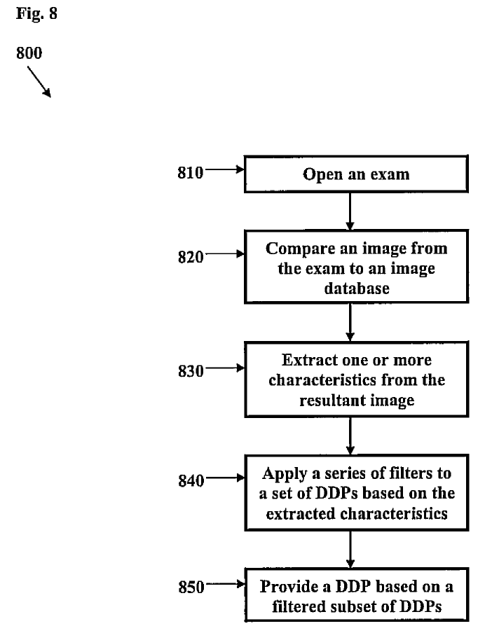

FIG. 8 illustrates a flow diagram for a method 800 for determining an appropriate banging protocol for display in accordance with an embodiment of the present invention.

At 810, an examination is opened. For example, an examination of a patient including a study having a plurality of images is opened from a data repository, such as a PACS.

At 820, an image from the exam is compared to an image database to identify a resultant image. For example, a cranial CT image from the exam is compared to a library or database of prior or reference images using an image recognition engine, such as a FIRE. Image recognition techniques are applied to the cranial CT image (the query image) to match it to a known image from the library.

At 830, one or more characterizations are extracted from the resultant image. For example, one or more characterizations, such as regions of interest, anatomy and/or other feature, procedure, modality, etc., are extracted from the library cranial CT image.

At 840, a series of filters are applied to a set of DDPs based on the extracted characteristic(s). The series of filters includes an image recognition filter and/or one or more filters including a modality filter, a procedure code filter, a body part filter, etc. The series of filters produces a subset of DDPs. For example, applying the series of filters to the characteristics extracted from the cranial CT image narrows a subset of DDPs to only or more that are relevant/appropriate to that type of image.

At 850, a DDP is provided for application to a display based on the filtered subset. For example, a particular DDP is selected from the subset of one or more DDPs resulting from the application of the filters.

One or more of the steps of the method 800 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

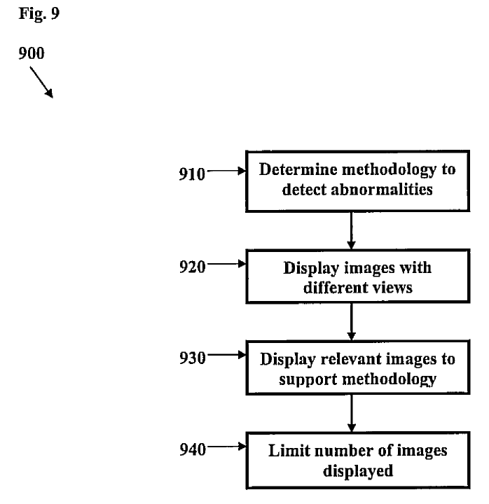

FIG. 9 illustrates a flow diagram for a method 900 for applying a banging protocol to a workstation display in accordance with an embodiment of the present invention. At 910, a type of methodology to detect abnormalities is determined. For example, a methodology to detect abnormalities based on a comparison between cardiac images taken before a patient has exercised and after a patient has exercised is determined. At 920, images are displayed with different views of the patient. For example, cardiac images showing different views of the patient's heart are displayed. At 930, relevant images to support the methodology are displayed. For example, cardiac images taken before the patient exercised and after the patient exercised are displayed adjacent to each other based on view to allow better comparison by a reviewer. At 940, a number of images displayed is limited by determining a minimum display size occupied by each image. For example, a minimum display size can be determined based on image resolution and monitor resolution to help ensure that pixels in the images are displayed on the monitor as well as the minimum displayed image size set by the radiologist. For example, if an image series includes data that is volumetric, then display the images in the series in stack mode. Volumetric data can be determined, for example, by checking that the DICOM header's image position data element difference from image to image is at a regular interval.

One or more of the steps of the method 900 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

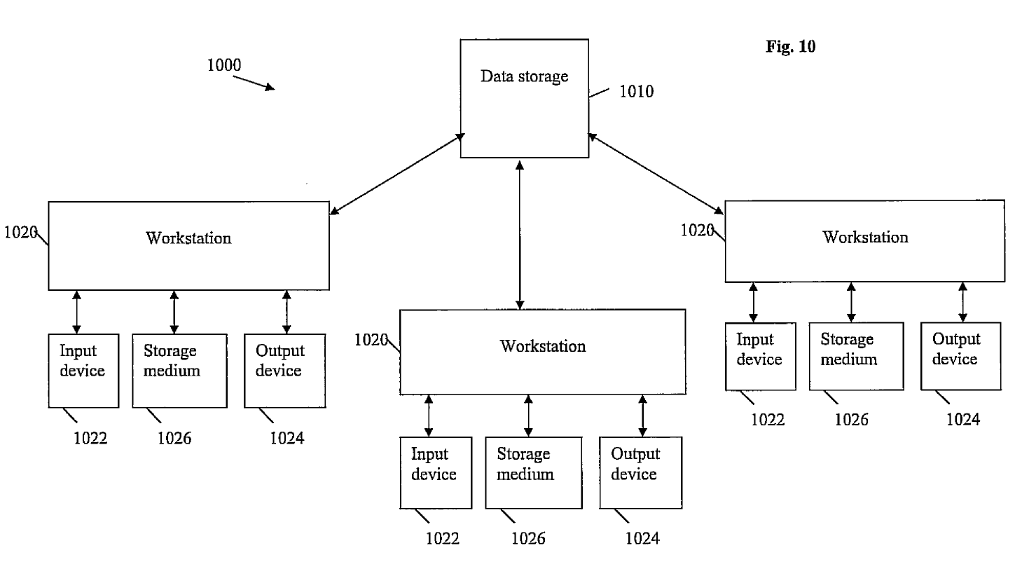

Certain embodiments described above may be implemented on a clinical information system, such as the system 1000 of FIG. 10. In certain embodiments, an interface including patient information and images may be viewed and/or constructed using a system such as system 1000 including at least one data storage 1010 and at least one workstation 1020. While three workstations 1020 are illustrated in system 1000, a larger or smaller number of workstations 1020 can be used in accordance with embodiments of the presently described technology. In addition, while one data storage 1010 is illustrated in system 1000, system 1000 can include more than one data storage 1010. For example, each of a plurality of entities (such as remote data storage facilities, hospitals or clinics) can each include one or more data stores 1010 in communication with one or more workstations 1020.

As illustrated in system 1000, one or more workstations 1020 can be in communication with at least one other workstation 1020 and/or at least one data storage 1010. Workstations 1020 can be located in a single physical location or in a plurality of locations. Workstations 1020 can be connected to and communicate via one or more networks.

Workstations 1020 can be directly attached to one or more data stores 1010 and/or communicate with data storage 1010 via one or more networks. Each workstation 1020 can be implemented using a specialized or general-purpose computer executing a computer program for carrying out the processes described herein. Workstations 1020 can be personal computers or host attached terminals, for example. If workstations 1020 are personal computers, the processing described herein can be shared by one or more data stores 1010 and a workstation 1020 by providing an applet to workstation 1020, for example.

Workstations 1020 include an input device 1022, an output device 1024 and a storage medium 1026. For example, workstations 1020 can include a mouse, stylus, microphone and/or keyboard as an input device. Workstations 1020 can include a computer monitor, liquid crystal display (“LCD”) screen, printer and/or speaker as an output device.

Storage medium 1026 of workstations 1020 is a computer-readable memory. For example, storage medium 1026 can include a computer hard drive, a compact disc (“CD”) drive, a USB thumb drive, or any other type of memory capable of storing one or more computer software applications. Storage medium 1026 can be included in workstations 1020 or physically remote from workstations 1020. For example, storage medium 1026 can be accessible by workstations 1020 through a wired or wireless network connection.

Storage medium 1026 includes a set of instructions for a computer. The set of instructions includes one or more routines capable of being run or performed by workstations 1020. The set of instructions can be embodied in one or more software applications or in computer code.

Data storage 1010 can be implemented using a variety of devices for storing electronic information such as a file transfer protocol (“FTP”) server, for example. Data storage 1010 includes electronic data. For example, data storage 1010 can store patient exam images and/or other information, electronic medical records, patient orders, etc., for a plurality of patients. Data storage 1010 may include and/or be in communication with one or more clinical information systems, for example.

Communication between workstations 1020, workstations 1020 and data storage 1010, and/or a plurality of data stores 1010 can be via any one or more types of known networks including a local area network (“LAN”), a wide area network (“WAN”), an intranet, or a global network (for example, Internet). Any two of workstations 1020 and data stores 1010 can be coupled to one another through multiple networks (for example, intranet and Internet) so that not all components of system 1000 are required to be coupled to one another through the same network.

Any workstations 1020 and/or data stores 1010 can be connected to a network or one another in a wired or wireless fashion. In an example embodiment, workstations 1020 and data store 1010 communicate via the Internet and each workstation 1020 executes a user interface application to directly connect to data store 1010. In another embodiment, workstation 1020 can execute a web browser to contact data store 1010. Alternatively, workstation 1020 can be implemented using a device programmed primarily for accessing data store 1010.

Data storage 1010 can be implemented using a server operating in response to a computer program stored in a storage medium accessible by the server. Data storage 1010 can operate as a network server (often referred to as a web server) to communicate with workstations 1020. Data storage 1010 can handle sending and receiving information to and from workstations 1020 and can perform associated tasks. Data storage 1010 can also include a firewall to prevent unauthorized access and enforce any limitations on authorized access. For instance, an administrator can have access to the entire system and have authority to modify portions of system 1000 and a staff member can only have access to view a subset of the data stored at data store 1010. In an example embodiment, the administrator has the ability to add new users, delete users and edit user privileges. The firewall can be implemented using conventional hardware and/or software.

Data store 1010 can also operate as an application server. Data store 1010 can execute one or more application programs to provide access to the data repository located on data store 1010. Processing can be shared by data store 1010 and workstations 1020 by providing an application (for example, a java applet). Alternatively, data store 1010 can include a stand-alone software application for performing a portion of the processing described herein. It is to be understood that separate servers may be used to implement the network server functions and the application server functions. Alternatively, the network server, firewall and the application server can be implemented by a single server executing computer programs to perform the requisite functions.

The storage device located at data storage 1010 can be implemented using a variety of devices for storing electronic information such as an FTP server. It is understood that the storage device can be implemented using memory contained in data store 1010 or it may be a separate physical device. The storage device can include a variety of information including a data warehouse containing data such as patient medical data, for example.

Data storage 1010 can also operate as a database server and coordinate access to application data including data stored on the storage device. Data storage 1010 can be physically stored as a single database with access restricted based on user characteristics or it can be physically stored in a variety of databases.

In an embodiment, data storage 1010 is configured to store data that is recorded with or associated with a time and/or date stamp. For example, a data entry can be stored in data storage 1010 along with a time and/or date at which the data was entered or recorded initially or at data storage 1010. The time/date information can be recorded along with the data as, for example, metadata. Alternatively, the time/date information can be recorded in the data in manner similar to the remainder of the data. In another alternative, the time/date information can be stored in a relational database or table and associated with the data via the database or table.

In an embodiment, data storage 1010 is configured to store image and/or other medical data for a patient. The medical data can include data such as numbers and text. The medical data can also include information describing medical events. For example, the medical data/events can include a name of a medical test performed on a patient. The medical data/events can also include the result(s) of a medical test performed on a patient. For example, the actual numerical result of a medical test can be stored as a result of a medical test. In another example, the result of a medical test can include a finding or analysis by a caregiver that entered as text.

Thus, certain embodiments provide systems and methods using an image itself to characterize the image and type of hanging protocol to be used for display of that image. Certain embodiments provide a technical effect of review of one or more images using image recognition techniques in comparison with a database of images to select a hanging protocol without reliance on image metadata, for example. Certain embodiments enhance prior hanging protocol methods to apply image recognition technology to characterize medical images in order to supplement explicit characterization when the other image information is missing or incomplete.

In certain embodiments, image recognition utilizes a database of images that have already been properly characterized. For, hanging protocol selection criteria, such as modality, procedure code, body part, etc., have been associated with the images in a preselected prototype image database. An unknown or poorly characterized image is then used as a query image on this database to identify closely matching cases. (e.g., images that “look like” the query image). When a query of the database results in a set of images, characterizations of the matching images can be used in place of the original query image to characterize that image. The unknown or poorly-characterized image is thus better defined because it resembles or “looks like” some other well-known, well-characterized image. If the query image resembles an axial CT image of a head, for example, then the image can be treated as such for the purposes of determining and applying a hanging protocol.

Certain embodiments help improve user workflow, accuracy, and satisfaction through reduction in incorrect hanging protocol determination and application. Certain embodiments use the image itself in characterization rather than relying on metadata stored with the image that may be missing, incomplete, or inaccurate.

Once an image type is determined, protocol-matching can be applied to select a hanging or display protocol. Since the images from similar types of radiologic procedures have a tendency to look alike, for example, review workstation software can review or “look at” the images to be displayed in situations where other metadata are missing in order to determine that the images appear to be images of a head CT using contrast and that a “CT-head with contrast” protocol should be used to display the exam.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

For example, certain embodiments provide a machine-readable storage medium including a set of instructions for execution on a processor. The set of instructions may include, for example, an input routine receiving a query image for display protocol selection. The set of instructions may also include an image retrieval routine receiving the query image and selecting a display protocol based on the image. The image retrieval routine compares the query image to a database of reference images to identify a resultant image, extracts one or more characteristics from the resultant image, and applies a series of filters including an image recognition filter to a set of display protocols based on the one or more characteristics to determine a subset of the set of display protocols. The set of instructions may also include an output routine providing a display protocol from the subset of the set of display protocols for display of the image study.

In certain embodiments, for example, the series of filters may include one or more of a modality filter, a procedure code filter, a historical filter, and a body part filter in addition to the image recognition filter. In certain embodiments, the image routine utilizes a flexible image retrieval routine to compare the query image to a database of characterized, reference medical images and assume that the query image shares one or more known characteristics of the resultant image. In certain embodiments, the database of reference images is updated dynamically based on the display protocol provided for the query image. In certain embodiments, the output routine provides an indication to a user of the display protocol regarding the provided display protocol and accepts user feedback regarding appropriateness of the display protocol for the image study. The feedback may be supplied to the image retrieval routine and/or the database, for example.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for determining a protocol for display of an image study, said method comprising:
comparing at least one query image from an image study to a database of reference images to identify at least one resultant image;
extracting one or more characteristics from the at least one resultant image;
applying a series of filters to a set of display protocols based on the one or more characteristics to determine a subset of the set of display protocols, at least one of the series of filters including an image recognition filter; and
providing a display protocol from the subset of the set of display protocols for display of the image study.

2. The method of claim 1, wherein the series of filters further comprises at least one of a modality filter, a procedure code filter, a historical filter, and a body part filter.

3. The method of claim 1, wherein the at least one resultant image is identified and the one or more characteristics are extracted using a flexible image retrieval engine.

4. The method of claim 3, wherein the engine assumes that the at least one query image shares one or more known characterizations of said at least one resultant image.

5. The method of claim 1, wherein the database of reference images comprises a database of characterized medical images.

6. The method of claim 1, wherein the database of reference images is updated dynamically based on the display protocol provided for the at least one query image.

7. The method of claim 1, further comprising applying said display protocol to display images in the image study, wherein the applying comprises:
determining a methodology used to detect abnormalities;
displaying images with different views from the image study;
displaying relevant images to support the methodology; and
limiting a number of images displayed

8. The method of claim 1, further comprising providing an indication to a user of the display protocol regarding the provided display protocol and accepting user feedback regarding appropriateness of the display protocol for the image study.

9. A system for determining a protocol for display of an image study, said system comprising:
an input receiving a query image for display protocol selection;
an image engine receiving the query image and selecting a display protocol based on the image, said image engine comparing the query image to a database of reference images to identify a resultant image, extracting one or more characteristics from the resultant image, and applying a series of filters including an image recognition filter to a set of display protocols based on the one or more characteristics to determine a subset of the set of display protocols; and
an output providing a display protocol from the subset of the set of display protocols for display of the image study.

10. The system of claim 9, wherein the series of filters further comprises at least one of a modality filter, a procedure code filter, a historical filter, and a body part filter in addition to the image recognition filter.

11. The system of claim 9, wherein the image engine further comprises a flexible image retrieval engine comparing the query image to a database of characterized, reference medical images and assuming that the query image shares one or more known characteristics of the resultant image.

12. The system of claim 9, wherein the database of reference images is updated dynamically based on the display protocol provided for the query image.

13. The system of claim 9, wherein the output provides an indication to a user of the display protocol regarding the provided display protocol and accepts user feedback regarding appropriateness of the display protocol for the image study and wherein the feedback is supplied to the image engine and the database.

14. The system of claim 9, wherein the image engine and the output apply the display protocol to display images in the image study by:
determining a methodology used to detect abnormalities;
displaying images with different views from the image study;
displaying relevant images to support the methodology; and
limiting a number of images displayed

15. The system of claim 9, wherein said image engine is at least one of deployed locally and deployed on a server accessible on a network.

16. A machine-readable storage medium including a set of instructions for execution on a processor, the set of instructions comprising:
an input routine receiving a query image for display protocol selection;
an image retrieval routine receiving the query image and selecting a display protocol based on the image, said image retrieval routine comparing the query image to a database of reference images to identify a resultant image, extracting one or more characteristics from the resultant image, and applying a series of filters including an image recognition filter to a set of display protocols based on the one or more characteristics to determine a subset of the set of display protocols; and
an output routine providing a display protocol from the subset of the set of display protocols for display of the image study.

17. The machine-readable medium of claim 16, wherein the series of filters further comprises at least one of a modality filter, a procedure code filter, a historical filter, and a body part filter in addition to the image recognition filter.

18. The machine-readable medium of claim 16, wherein the image retrieval routine further comprises a flexible image retrieval routine comparing the query image to a database of characterized, reference medical images and assuming that the query image shares one or more known characteristics of the resultant image.

19. The machine-readable medium of claim 16, wherein the database of reference images is updated dynamically based on the display protocol provided for the query image.

20. The machine-readable medium of claim 16, wherein the output routine provides an indication to a user of the display protocol regarding the provided display protocol and accepts user feedback regarding appropriateness of the display protocol for the image study and wherein the feedback is supplied to the image retrieval routine.
